(19) United States
(12) Patent Application Publication
(10) Pub. No.: US 2015/0044021 A1
(43) Pub. Date: Feb. 12, 2015

(54) TURBINE SYSTEM WITH THREE TURBINES COUPLED TO A CENTRAL GEARBOX AND METHOD FOR OPERATING A WORK MACHINE

(71) Applicant: Siemens Aktiengesellschaft, Munich (DE)

(72) Inventors: Thomas Müller, Einhausen (DE); Volker Neumann, Grunstadt (DE); Marc Overath, Worms (DE); Matthias Schleer, Freinsheim (DE)

(73) Assignee: Siemens Aktiengesellschaft, Munich (DE)

(21) Appl. No.: 14/386,798

(22) PCT Filed: Mar. 15, 2013
(86) PCT No.: PCT/EP2013/055341

§ 371 Date: Sep. 20, 2014

(30) Foreign Application Priority Data
Mar. 29, 2012 (DE) 102012205159.7

(51) Int. Cl. F01D 15/12; F01D 1/20

(52) U.S. Cl. CPC F01D 15/12; F01D 1/20; F05D 2260/40
USPC 415/1; 415/68

(57) ABSTRACT

A turbine system and a method for operating a work machine are provided herein. The turbine system including: a first, a second, and a third turbine, a central gearbox mechanically coupled on the input side to the three turbines and having a mechanical connection on the output side for connecting a work machine, a first fluid line for conveying a working fluid from the first turbine to the second turbine, a second fluid line for conveying the working fluid from the second turbine to the third turbine, a first connecting unit designed such that a first partial mass flow of the working fluid can be removed from the first fluid line or supplied to the first fluid line, and a second connecting unit designed such that a second partial mass flow of the working fluid can be removed from the second fluid line or supplied to the second fluid line.

### CROSS REFERENCE TO RELATED APPLICATIONS

This application is the US National Stage of International Application No. PCT/EP2013/055341 filed Mar. 15, 2013, and claims the benefit thereof. The International Application claims the benefit of German Application No. DE 102012205159.7 filed Mar. 29, 2012. All of the applications are incorporated by reference herein in their entirety.

### FIELD OF INVENTION

The present invention relates generally to the field of turbine technology. The present invention relates in particular to a turbine system which has multiple turbines which, in terms of the flow of a working fluid, are connected in series and which, together, can drive a work machine. The present invention also relates to a turbine installation having a turbine system of said type and having a work machine mechanically coupled to the turbine system. The present invention also relates to a method for operating a work machine by means of a turbine system of said type.

### BACKGROUND OF INVENTION

For the conversion of thermal energy into mechanical energy, use is often made of turbines, and in particular steam turbines. In the operation of known turbine or steam turbine systems, the working fluid or the steam is expanded along the flow direction, typically across a turbine with a turbine shaft. Here, the turbine may be a so-called multi-stage turbine which has multiple identical or different arrangements of in each case one rotor blade row and one stator blade row (guide blade row). The turbine shaft drives a work machine either directly or indirectly via a separate gearbox.

Alternatively, a turbine system is also known in which two separate turbines, which each have a turbine housing, are traversed in series by a flow of the working fluid. In this case, the two turbines are arranged on one gearbox shaft or on two separate gearbox shafts. The two turbines drive the work machine via the gearbox shaft. Owing to the normally low number of rotor blade rows in the two turbines that are typically used for a turbine system of said type, the thermodynamic efficiency of a turbine system of said type is relatively low.

### SUMMARY OF INVENTION

It is an object of the present invention to provide a turbine system that can be realized in a simple manner, a turbine installation, and a method for operating a work machine with good thermodynamic efficiency.

Said object is achieved by means of the subjects of the independent claims. Advantageous embodiments, further features and details of the present invention will emerge from the dependent claims, from the description and from the drawings. Here, features and details described in conjunction with the turbine system self-evidently also apply in conjunction with the turbine installation and with the method for operating a work machine. The same applies conversely, such that, with regard to the disclosure, reference can always be made to the individual aspects of the invention reciprocally.

According to a first aspect of the invention, a turbine system is described, which has (a) a first turbine, (b) a second turbine, (c) a third turbine, (d) a central gearbox which is mechanically coupled at the input side to the three turbines and which has, at the output side, a mechanical connection to which a work machine which consumes mechanical energy can be connected, (e) a first fluid line for conducting a working fluid from the first turbine to the second turbine, (f) a second fluid line for conducting the working fluid from the second turbine to the third turbine, (g) a first connection device which is assigned to the first fluid line and which is designed such that a first partial mass flow of the working fluid can be extracted from the first fluid line or supplied to the first fluid line, and (h) a second connection device which is assigned to the second fluid line and which is designed such that a second partial mass flow of the working fluid can be extracted from the second fluid line or supplied to the second fluid line.

The described turbine system is based on the realization that, in the case of a turbine system that has at least three turbines, it is not necessary for all of the turbines to be arranged on a common shaft, and instead, said turbines can be mechanically coupled to a central gearbox. The turbines of the described turbine system are connected in series with regard to the flow paths of the working fluid, wherein the second turbine is connected downstream of the first turbine and the third turbine is connected downstream of the second turbine. Here, the working fluid which has performed work in the first turbine and which subsequently exits the first turbine can be transferred to the second turbine via the first fluid line. Correspondingly, the working fluid which has performed work in the second turbine and which subsequently exits the second turbine can be transferred to the third turbine via the second fluid line.

The described turbine system with a central gearbox, by contrast to a conventional turbine system in which all of the turbines are coupled to a common, relatively long shaft, makes it possible for the individual turbines to be arranged no longer in one elongate row but in a flexible manner in a spatially compact configuration. In this way, the described turbine system can be realized within a relatively small structural space. Owing to the possibility of flexible configuration of the spatial arrangement of the individual turbines, it is possible for the described turbine system to be adapted in a relatively simple manner to a specification predefined by a customer. Furthermore, if required, the described turbine system can be relatively easily converted and for example adapted correspondingly in the event of changed operating parameters. In the event of alteration, maintenance or commissioning, it is furthermore possible to ensure particularly easy accessibility to the individual components of the described turbine system. Furthermore, the described turbine system can be realized at relatively low cost.

A further advantage of the turbine system described in this document consists in that, by contrast to known turbine systems, in which the individual turbines are coupled to a common, relatively long shaft, it is possible to use multiple short individual turbine shafts. It is advantageously possible in this way to realize particularly good so-called rapid-start capability.

In the described turbine system, according to the invention, two successive turbines are coupled to one another via a fluid line. Since, owing to the coupling to the central gearbox, the turbines are no longer arranged in a row, the fluid lines each have a profile that permits easy supply and/or discharge of working fluid. This means that the described connection devices, which may be realized in each case as a simple branching point, such as for example a T-piece, can be installed in the corresponding fluid line without accessibility or space problems impeding the installation of the corresponding connection device. It is thus possible in a simple manner for partial mass flows of the working fluid to be supplied to the respective fluid line from an external location or discharged from the respective fluid line to an external location.

The described turbines may in particular be turbines which in each case extract energy from the working fluid solely on the basis of an expansion of the working fluid, and which do not have a compressor stage in addition to an expansion stage.

The working fluid may be any pressurized fluid which is capable of performing mechanical work when it passes through the respective turbine. The working fluid may in particular be vapor (for example steam) that has been generated by a steam generator. Here, the steam generator may be a power plant which generates the steam primarily for use by the described turbine system. The steam generator may however also be a plant which generates the steam primarily for other processes (for example for cleaning and/or sterilization purposes) and which supplies the steam to the described turbine system only when the steam is not presently being used for said processes.

The working fluid may also be a simple gas which has previously been compressed for the purpose of temporarily storing energy. Here, the gas may be compressed, for example by a compressor operated by electrical energy, during a time period in which, for example, a greater amount of electrical energy is provided by regenerative energy sources than is presently being consumed.

The described turbines may be any type of turbines in which the working fluid drives a rotor. The structural design of the turbines is self-evidently dependent, as is known, on the working fluid that is used. If steam is used as working fluid, the turbines are so-called steam turbines. If the working medium is a pressurized gas, then the turbines are generally referred to as gas expansion turbines.

In one exemplary embodiment of the invention, the turbine system furthermore has (a) a first regulating device, assigned to the first connection device, for adjusting the magnitude of the first partial mass flow, and/or (b) a second regulating device, assigned to the second connection device, for adjusting the magnitude of the second partial mass flow.

The described regulating devices may each have a control element which, for example by way of a constriction or widening of its cross section, can determine the magnitude of the respective (partial) mass flow which is fed via the respective connection device into the respective fluid line from an external location or released from the respective fluid line to an external location. Furthermore, the described regulating devices may each have a suitable sensor which detects a state variable such as, for example, the pressure of the working fluid in the respective fluid line, wherein the control element, for example an adjustable valve or an adjustable throttle, can, based on the detected value for said state variable, adjust the respective (partial) mass flow such that said state variable remains at least approximately constant even under changing operating conditions. It is thus possible, through skilful regulation of the (partial) mass flows of the working fluid, to create and/or maintain, for each turbine, conditions that ensure high efficiency for each individual turbine and thus self-evidently also for the overall turbine system.

It is pointed out that a coupling-out or extraction of a partial mass flow does not imperatively mean that said partial mass flow is lost with regard to energy generation. Said partial mass flow may for example be supplied back to the described turbine system at some other location via another connection device. Correspondingly, a (partial) mass flow fed into the turbine system from an external location may also have been extracted from the main mass flow of the described turbine system at some other location by means of another connection device. The use of at least one buffer store for temporarily storing working fluid is also possible in this context.

In descriptive terms, the two regulating devices in conjunction with the respectively associated connection devices make it possible to realize precisely defined intermediate pressure stages from which the working fluid can be extracted in a simple and controlled manner and/or to which the working fluid can be supplied in a simple and controlled manner. In this way, the flexibility of the overall turbine system is increased considerably, in particular in the presence of fluctuating load.

In a further exemplary embodiment of the invention, the first turbine and the second turbine are coupled to the central gearbox by means of a common shaft, wherein in particular, one of the two turbines is arranged on a first side of the central gearbox and the other of the two turbines is arranged on a second side of the central gearbox. Here, the first side is situated opposite the second side. This has the advantage that said two turbines are mechanically coupled to the central gearbox by means of a common coupling element, and in particular by means of a common pinion, wherein the common coupling element is attached to the common shaft. In this way, only two coupling elements are required on the gearbox in order for the total of at least three turbines to be coupled to the central gearbox.

The common shaft may be a single-piece or a multi-piece shaft. In the case of a multi-piece shaft, the multiple pieces of the common shaft should however be fixedly connected to one another such that the rotors of the two turbines are coupled rotationally conjointly to one another.

The rotors of the two turbines may be arranged in an “overhung” configuration, that is to say without a bearing arrangement for the turbine in the respective turbine housing. Here, the rotor or the entire turbine is situated outside the bearing points of the common shaft. This has the advantage that a suitable bearing arrangement for the common shaft only needs to be provided in or on the central gearbox. Here, a suitable bearing arrangement may be realized for example by means of two bearings, wherein one of the two bearings is arranged on the first side and the other of the two bearings is arranged on the opposite, second side of the central gearbox.

In a further exemplary embodiment of the invention, the first turbine and the third turbine are coupled to the central gearbox such that the first turbine can be operated with a first rotational frequency and the third turbine can be operated with a second rotational frequency, wherein the first rotational frequency differs from the second rotational frequency. Here, a certain ratio between the first rotational frequency and the second rotational frequency can be set through the selection of respectively suitable transmission ratios for the coupling between the respective turbine and the central gearbox. It is then possible, through suitable selection of the transmission ratio, for each turbine to be operated in an optimum rotational speed range. In this way, it is possible to achieve particularly high efficiency of the individual turbines and thus also of the turbine system as a whole.

In descriptive terms, the shaft rotational speeds of the first turbine and of the second turbine can be adapted to the respective turbines and in particular to the pressure levels associated with the respective turbines. In this way, it is possible in a simple manner to achieve an optimization of the described turbine system with regard to its efficiency or with regard to its effectiveness.

In a further exemplary embodiment of the invention, at least one of the three turbines is a radial turbine.

Since a radial turbine is typically of shorter structural form than an axial turbine, the overall turbine system can thus be realized in a particularly compact structural form.

Of the multiplicity of turbines connected in series, it is possible in particular for that turbine to which the (compressed) working fluid is supplied first to be in the form of a radial turbine. This has the advantage that a radial turbine then constitutes the first regulating step for the overall turbine system, by means of which, in a controlled manner, the overall mass flow of working fluid that flows through the overall turbine system is set. For this purpose, said (first) radial turbine may be equipped with suitable regulating valves by means of which the overall mass flow of working fluid can be set in a known manner.

In a further exemplary embodiment of the invention, at least one of the three turbines is an axial turbine.

The axial turbine, in which the working fluid flows through the corresponding turbine housing in the axial direction and thus drives the rotor, may be composed of one stage or preferably of multiple stages, wherein each stage has (a) a row of rotating rotor blades attached to the rotor, and (b) a row of static guide blades attached to the housing.

In a further exemplary embodiment of the invention, the rotor of the axial turbine is coupled to an axial shaft which is mounted on the side of the central gearbox and which is arranged, without bearings, in a housing of the axial turbine. This means that the rotor or the axial shaft of the axial turbine is arranged in an “overhung” configuration on one side. A bearing arrangement is thus provided only on that section of the axial shaft which is situated outside the axial turbine and which is assigned to the central gearbox. Here, the bearing arrangement on the central gearbox may be realized by means of one or more bearings offset axially with respect to one another.

In descriptive terms, this means that there is a mechanical connection between the axial turbine and the central gearbox without interposed bearing points. The axial shaft is mounted not in the turbine housing but rather only in or on a housing of the central gearbox. In this connection, it is pointed out that an “overhung” bearing arrangement in the housing of the turbine offers the advantage inter alia that expansions caused by fluctuating temperatures that are encountered in particular under fluctuating loads do not lead to distortion of the axial shaft in relation to bearing arrangements in the turbine housing.

In a further exemplary embodiment of the invention, the rotor of the axial turbine has multiple turbine stages, wherein each turbine stage has, arranged around the axial shaft, (a) a row of rotatable rotor blades attached to the rotor, and (b) a row of static guide blades attached to the housing. This has the advantage that a higher level of efficiency can be attained in relation to an axial turbine with only one turbine stage.

In a further exemplary embodiment of the invention, the rotor blades of a row are attached to a rotor blade carrier, and the multiple rotor blade carriers are fixed to the axial shaft by means of a tensile device.

The tensile device may for example be a so-called tension anchor which comprises a thread formed on the axial shaft and a nut that engages into the thread. In this way, multiple rotor blade carriers can be fixed rotationally conjointly to the axial shaft in a particularly simple and nevertheless reliable manner.

In a further exemplary embodiment of the invention, the turbine system furthermore has (a) a fourth turbine which is mechanically coupled to the central gearbox, (b) a third fluid line for conducting the working fluid from the third turbine to the fourth turbine, and (c) a third connection device which is assigned to the third fluid line and which is designed such that a third partial mass flow of the working fluid can be extracted from the third fluid line or supplied to the third fluid line. This means that the mechanical connection that can drive the work machine is now driven by a total of at least four turbines. The efficiency of the described turbine system can be yet further improved in this way.

It is pointed out that it is also possible for more than four turbines to be coupled directly or indirectly to the central gearbox. It is preferable here if, between in each case two turbines which are adjacent in terms of the flow direction of the working medium, there is provided a fluid line which is provided with a connection device, such that a corresponding partial mass flow of the working fluid can be extracted from the respective fluid line or supplied to the respective fluid line. It is furthermore preferable for the respective connection device to be assigned a regulating device such that the magnitude of the respective partial mass flow can be precisely set and, in this way, optimal operation with regard to the efficiency of the turbine system can be ensured.

According to a further aspect of the invention, a turbine installation is described which has (a) a turbine system of the above-described type and (b) a work machine which is coupled to the mechanical connection of the central gearbox.

The described turbine installation is based on the realization that the above-mentioned turbine system can be mechanically coupled to a work machine such that energy contained in the working fluid can be extracted from the working fluid and transmitted mechanically to the work machine.

A rotor of the work machine may be mechanically coupled to the mechanical connection of the central gearbox in rotationally conjoint fashion by means of a clutch or a flange. The work machine may in particular be an electrical generator which can be used for generating electricity. The work machine may however also be a mechanical machine which utilizes the mechanical energy supplied to it by the described turbine system in a suitable manner for performing mechanical activities. The work machine may for example be a pump, a compressor, a fan and/or a press.

According to a further aspect of the invention, a method for operating a work machine is described. The described method comprises the steps of (a) providing an energy-containing working fluid, (b) supplying the working fluid to a turbine system of the above-described type, wherein the turbine system extracts at least a part of the energy of the working fluid and converts at least a part of the extracted energy into mechanical work, and (c) operating the work machine with the converted mechanical work.

The described method is also based on the realization that the work machine can be operated in an efficient manner using the turbine system specified above. Here, in accordance with generally recognized fundamental principles of thermodynamics, the energy is extracted from the working fluid and converted into mechanical energy, which is then transmitted to the work machine by means of a purely mechanical coupling.

In this context, the expression “energy-containing working fluid” may be understood in particular to mean that the working fluid has been thermodynamically charged with energy, such that the working fluid is in particular at a high temperature and/or a high pressure. If the working fluid is a vapor, for example steam, then the hot and/or highly pressurized steam additionally contains evaporation energy which, when the steam condenses, leads to a release of condensation energy which can then likewise be converted into mechanical work.

It is pointed out that embodiments of the invention have been described with reference to different invention subjects. In particular, some embodiments of the invention have been described by way of device claims and other embodiments of the invention have been described by way of method claims. However, it will be immediately clear to a person skilled in the art reading this application that, unless explicitly stated otherwise, in addition to a combination of features pertaining to one type of invention subject, any combination of features pertaining to different types of invention subjects is also possible.

### BRIEF DESCRIPTION OF THE DRAWINGS

Further advantages and features of the present invention will emerge from the following exemplary description of presently preferred embodiments.

FIG. 1 shows, in a schematic illustration, a turbine installation having four steam turbines which drive a work machine via a common gearbox.

FIG. 2 shows, in a perspective illustration, a turbine installation having three steam turbines which jointly drive an electrical generator.

FIG. 3 shows a turbine system having one radial turbine and two axial turbines, which can drive a work machine via a common gearbox.

FIG. 4 shows a turbine system having one radial turbine and three axial turbines, which can drive a work machine via a common gearbox.

### DETAILED DESCRIPTION OF INVENTION

It is pointed out that features or components of different embodiments which are identical or at least functionally identical to the corresponding features or components of the embodiment are denoted by the same reference signs or by different reference signs which differ only in terms of their first digit from the reference sign of a (functionally) corresponding feature or of a (functionally) corresponding component. To avoid unnecessary repetition, features or components already explained on the basis of a previously described embodiment will not be explained in any more detail later in the text.

It is pointed out that the embodiments described below constitute merely a limited selection of possible design variants of the invention. In particular, it is possible for the features of individual embodiments to be combined with one another in a suitable manner such that, with the design variants explicitly presented here, a multiplicity of different embodiments is to be regarded as being disclosed in an obvious manner to a person skilled in the art.

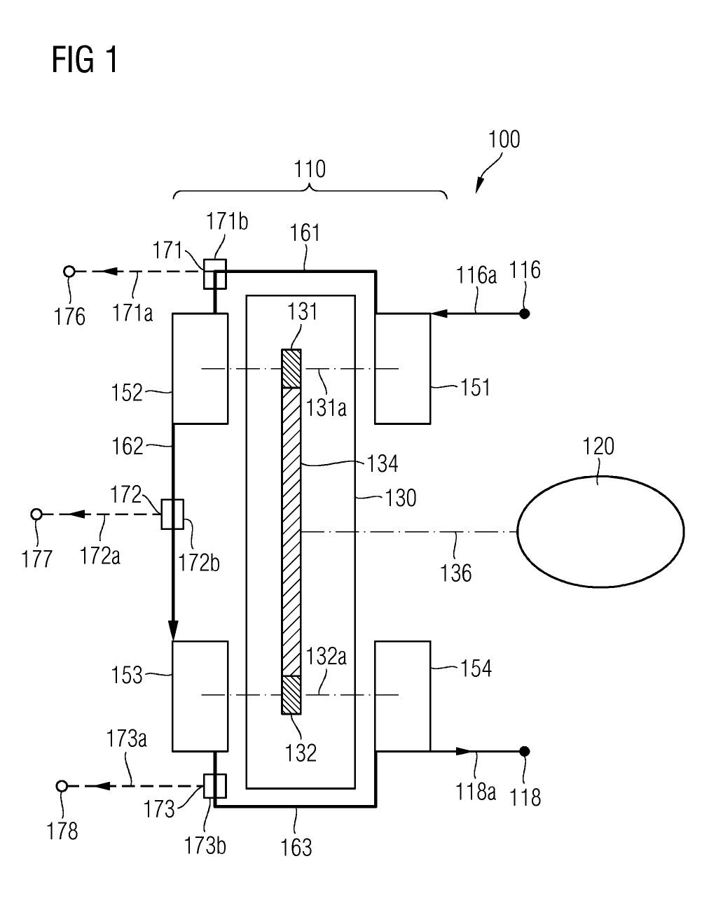

FIG. 1 shows, in a schematic illustration, a turbine installation 100 according to an exemplary embodiment of the invention. The turbine installation 100 has a turbine system 110 which drives a work machine 120. The work machine 120 may in particular be an electrical generator which can be used for generating electricity. The work machine 120 may however also be any mechanical machine which utilizes the mechanical energy supplied to it by the turbine system 110 in a suitable manner for performing mechanical activities, for example for pumping, compression and/or pressing processes.

The turbine system 110 has four steam turbines, a first steam turbine 151, a second steam turbine 152, a third steam turbine 153 and a fourth steam turbine 154. As can be seen from FIG. 1, said steam turbines 151, 152, 153 and 154 are connected in series with regard to the general flow direction of a working fluid. The working fluid, which in the exemplary embodiment illustrated here is steam, flows, having been intensely superheated by a steam generator, into a fluid inlet 116. A corresponding inlet mass flow 116a of steam then flows into the first steam turbine 151 in which, in a known manner, the steam performs mechanical work and, in the process, drives a rotor (not illustrated in FIG. 1) of the first steam turbine 151.

Steam which emerges from the first steam turbine 151, and which still contains a considerable amount of energy that has not been converted into mechanical work by the relatively short first steam turbine 151, then flows via a first fluid line 161 into the second steam turbine 152, in which it is likewise the case that energy contained in the steam is converted into mechanical work.

The first fluid line 161 has a first connection device 171 which, in the exemplary embodiment illustrated here, is a simple branching point, for example a so-called T-piece. Via the connection device 171, a first partial mass flow 171a of working fluid can be coupled out of the overall mass flow to a first fluid port 176, or an additional mass flow of working fluid can be fed into the first fluid line from the first fluid port 176. In this way, the energy supplied to the second steam turbine 152 can be adjusted, and thus the power of the overall turbine system 110 can be adapted.

The first connection device 171 and/or the first fluid line 161 is assigned a first regulating device 171b which has a pressure sensor (not illustrated) by means of which the pressure of the working fluid in the fluid line 161 is detected. By means of an adjustable valve (likewise not illustrated), it is possible on the basis of the detected pressure for the (partial) mass flow to be adjusted such that the pressure remains at least approximately constant even under changing operating conditions. It is thus possible, through skilful regulation of the (partial) mass flows of the working fluid, for the steam turbine 152 to be operated in an optimum operating mode. In this way, it is possible to ensure a high level of efficiency for the steam turbine 152 and thus self-evidently also for the overall turbine system 110.

The steam which emerges from the second steam turbine 152, and which still contains a considerable amount of still-unutilized energy, then flows via a second fluid line 162 into the third steam turbine 153. As in the first fluid line 161, the second fluid line 162 also has arranged therein a (second) connection device 172 in the form of a T-piece and a (second) regulating device 172b, such that it is likewise possible in a controlled manner for a second partial mass flow 172 to be transferred to a second fluid port 177 or to be fed into the second fluid line 162 from the second fluid port 177.

Correspondingly, the third steam turbine 153 and the fourth steam turbine 154 connected downstream of the third steam turbine 153 are connected to one another via a third fluid line 163. Furthermore, in the third fluid line, there is situated a third connection device 173 by means of which a third partial mass flow 173a of steam can be branched off from the third fluid line 163 and supplied to a third fluid port 178, and/or by means of which additional steam can be fed into the third fluid line 163 from the third fluid port 178. A third regulating device 173b ensures that the corresponding extraction or supply of steam takes place in a regulated manner.

It is pointed out that the pressure sensor of the respective regulating device 171b, 172b, 173b is preferably arranged in the respective fluid line 161, 162, 163 upstream of the branching point of the respective connection device 171, 172, 173. Furthermore, the adjustable valve of the respective regulating device 171b, 172b, 173b is preferably arranged in the respective fluid line 161, 162, 163 downstream of the branching point of the respective connection device 171, 172, 173. In particular, the adjustable valve may be arranged directly upstream of or on the housing of the subsequent turbine.

An outlet mass flow 118a of steam which has passed through all of the turbines 151, 152, 153 and 154 or which has been fed into the turbine system 110 via one of the fluid ports 176, 177 or 178 emerges at a fluid outlet 118. The emerging steam can then, in a known manner, be supplied to a heater (not illustrated). Said heater may in turn be coupled to the fluid inlet 116, such that a closed circuit for working fluid or steam can be realized.

As can be seen from FIG. 1, the rotors of the steam turbines 151 and 152 are connected to one another via a common shaft 131a. This means that the rotational frequency of the steam turbines 151 and 152 is the same. It would alternatively also be possible for a gearbox (not illustrated) to be connected between the two rotors of the steam turbines 151 and 152, such that a first rotational frequency of the rotor of the first steam turbine 151 and a second rotational frequency of the rotor of the second steam turbine 152 are in a fixed ratio with respect to one another. Correspondingly, the two rotors of the steam turbines 153 and 154 are connected to one another via a common shaft 132a or, if appropriate, are mechanically coupled to one another via an additional gearbox.

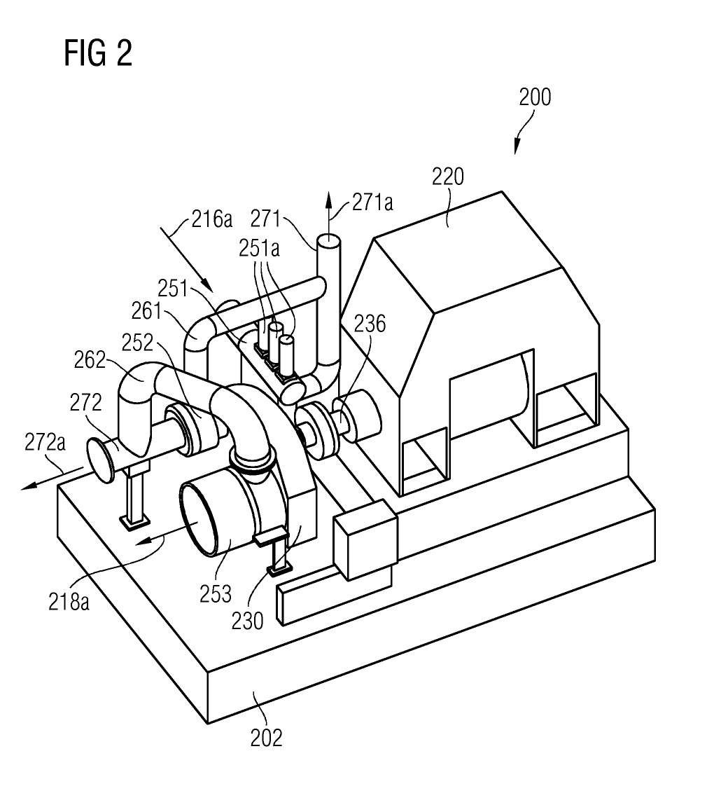

A central constituent of the turbine system 110 described here is a central gearbox 130 which has a gearwheel 134 and two pinions. A first pinion 131 of the two pinions is attached to the shaft 131a. The second pinion 132 is attached to the shaft 132a. Both pinions 131 and 132 mesh with the gearwheel 134. The central gearbox 130 furthermore has a central drive shaft 136 which connects the gearwheel 134 and the drive machine 120 to one another. FIG. 2 shows, in a perspective illustration, a turbine installation 200 according to a further exemplary embodiment of the invention. The turbine installation 200 has a foundation slab 202 on which at least the main components of the turbine installation 200 are mounted or installed. The turbine installation 200 has (a) a first steam turbine 251 in the form of a radial turbine, (b) a second turbine 252 in the form of an axial turbine, and (c) a third steam turbine 253 likewise in the form of an axial turbine 253. All of the turbines 251, 252 and 253, or the rotors of said turbines 251, 252 and 253, are coupled to one another via a central gearbox 230. The central gearbox 230 is mechanically coupled at the outlet side via a drive shaft 236 to a work machine 220 in the form of an electrical generator.

An inlet mass flow 216a of working fluid is supplied to the first steam turbine 251. The magnitude of said inlet mass flow 216a, which is regulated by means of a multiplicity of regulating valves 251a, thus significantly determines the power of the overall turbine installation 200. Working fluid emerging from the first steam turbine 251 is supplied via a first fluid line 261 to the second steam turbine 252. Working fluid emerging from the second steam turbine 252 is supplied via a second fluid line 262 to the third steam turbine 253.

To regulate the mass flow of working fluid between in each case two steam turbines 251 and 252, or 252 and 253, which are adjacent with regard to the flow direction of the working fluid, there is situated in the first fluid line 261 a first connection device 271 together with a first regulating device that is not illustrated in FIG. 2, such that a first partial mass flow 271a can be coupled out of the first fluid line 261, or alternatively, a mass flow that is not illustrated can be fed into the first fluid line 261. Correspondingly, in the second fluid line 262, there is situated a second connection device 272 together with a second regulating device that is not illustrated in FIG. 2, such that a second partial mass flow 272a can be coupled out of the second fluid line 262, or alternatively, a mass flow that is not illustrated can be fed into the second fluid line 262.

An outlet mass flow 218a of working fluid which has passed through all of the turbines 251, 252 and 253 or which has been fed into the turbine installation 200 via one of the connection devices 271 or 272, is then supplied to a heater (not illustrated). Said heater may in turn provide the inlet mass flow 216a, such that a closed circuit for working fluid or steam can be realized.

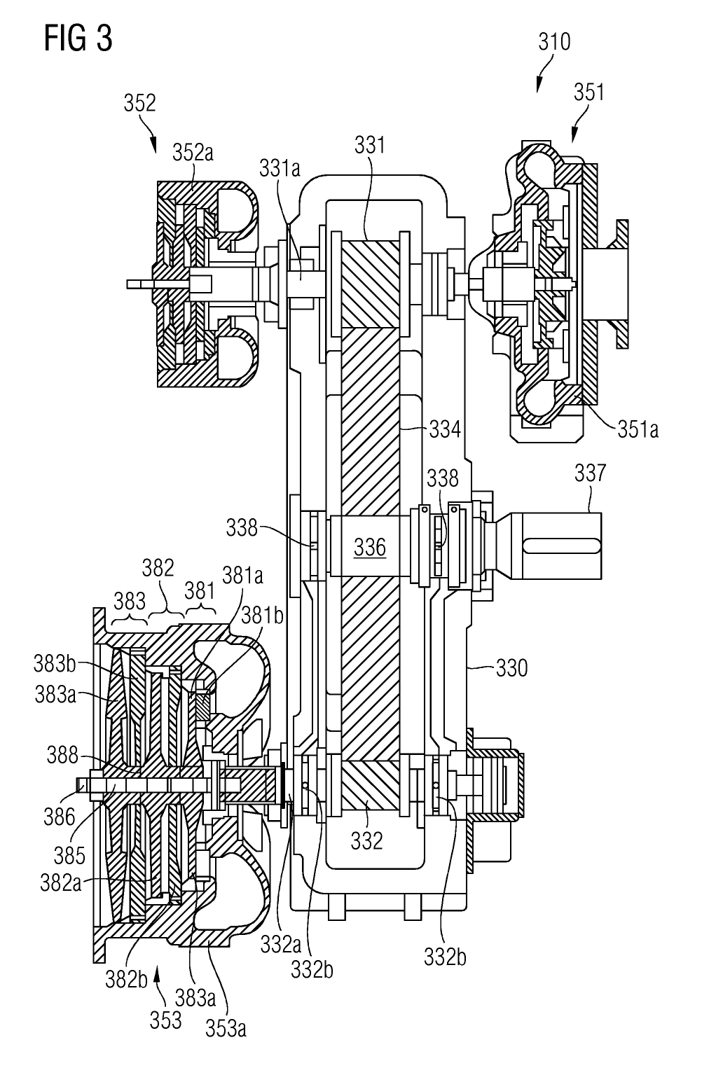

FIG. 3 shows a turbine system 310 having a first steam turbine 351 in the form of a radial turbine, having a second steam turbine 352 in the form of an axial turbine, and having a third steam turbine 353 likewise in the form of an axial turbine. The first steam turbine 351 and the second steam turbine 352 are connected to one another via a first fluid line (not illustrated). The first steam turbine 351 has a first housing 351a, the second steam turbine 352 has a second housing 352a, and the third steam turbine 353 has a third housing 353a.

As in the exemplary embodiments presented above, the first fluid line is assigned a first connection device (likewise not illustrated) and a first regulating device (likewise not illustrated). The second steam turbine 352 and the third steam turbine 353 are connected to one another via a second fluid line (not illustrated), which is assigned a second connection device (likewise not illustrated) and a second regulating device (likewise not illustrated).

The three steam turbines are mechanically coupled to one another by means of a central gearbox 330. In the gearbox 330, both a first pinion 331 and a second pinion 332 mesh with a gearwheel 334. Here, the ratio between the rotational frequency of the rotors of the first and second steam turbines 351 and 352 and the rotational frequency of the rotor of the third steam turbine 353a is determined by a ratio between (a) a first number of teeth of the first pinion 331 which is arranged on a shaft 331a which connects the rotors of the two steam turbines 351 and 352 to one another and (b) a second number of teeth of the second pinion 332 which is arranged on a shaft 332a of the rotor of the third steam turbine 353. In the exemplary embodiment illustrated here, the first pinion 331 has a greater number of teeth than the second pinion 332, such that the rotational frequency of the rotors of the first and second steam turbines 351 and 352 is higher than the rotational frequency of the rotor of the third steam turbine 353.

The gearwheel 334 is arranged on a central drive shaft 336, which is mounted in a housing of the central gearbox 330 by means of two bearings 338. In FIG. 3, on the right-hand end of the central drive shaft 336, there is provided a mechanical connection 337 in the form of a flange, to which a drive machine (not illustrated in FIG. 3) can be connected.

As can be seen from FIG. 3, the two axial turbines 352 and 353 each have a multi-stage configuration of in each case one guide blade and possibly one rotor blade. Here, a rotor blade 381a and a guide blade 381b are assigned to a first stage 381 of the multi-stage axial turbine 353. A rotor blade 382a and a guide blade 382b are assigned to a second stage 382 of the multi-stage axial turbine 353. A rotor blade 383a and a guide blade 383b are assigned to a third stage 383 of the multi-stage axial turbine 353. The rotor blades 381a, 382a and 383a are arranged on an axial shaft 385 of the steam turbine 353. The axial shaft 385 is connected rotationally conjointly to the shaft 332a.

In the exemplary embodiment illustrated here, adjacent rotor blades, that is to say the rotor blades 381a and 382a and the rotor blades 382a and 383a, are, by means of an axial spur toothing, arranged rotationally conjointly with respect to one another on the axial shaft 385. A tension anchor connection, which is realized by means of a nut 386 in conjunction with an external thread formed on the axial shaft 385, ensures secure locking of the rotor blades 381a, 381b and 381c on the axial shaft 385.

It is pointed out at this juncture that, for clarity, in FIG. 3, the different stages 381, 382 and 383 and the respectively associated components are designated by reference signs only in the steam turbine 353.

As can also be seen from FIG. 3, the rotors of the two axial turbines 352 and 353 are mounted in an overhung configuration. This means that the rotors of the two steam turbines 352 and 353 are mounted not in the respective turbine housing 352a and 353a but only (by means of the shaft 332a) on the housing of the central gearbox 330. For this purpose, a respective bearing 332b is provided on the left and on the right on the housing of the central gearbox 330. No bearing elements are provided in the turbine housing 352a and 353a, this thus corresponding to an “overhung arrangement” of the respective rotor.

It is pointed out that, in the exemplary embodiment illustrated here, the bearings 332b are radial bearings. An axial bearing action is realized here by means of the second pinion 332, which, as can be seen in FIG. 3, has a respective shoulder on the left and on the right, wherein the two shoulders engage with the gearwheel 334 in the axial direction. In this way, leftward axial thrust generated during the operation of the steam turbine 353 is transmitted via the two shoulders of the pinion 332 and via the gearwheel 334 to the bearing 338 and is absorbed by the latter.

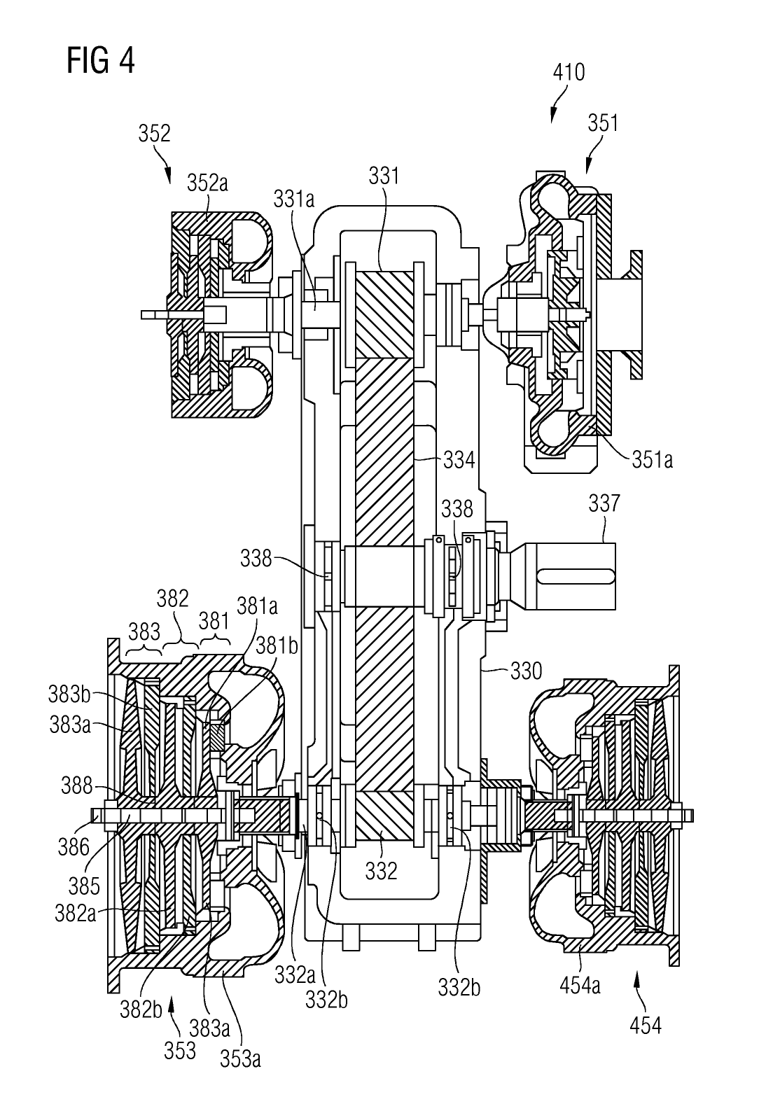

FIG. 4 shows a turbine system 410, which differs from the turbine system 310 illustrated in FIG. 3 merely by the fact that a fourth steam turbine 454, in the form of an axial turbine, is additionally arranged on the shaft 332a, which fourth steam turbine has a housing 454a. In this way, in this exemplary embodiment, the central drive shaft 336 is driven by a total of four steam turbines, wherein the fourth steam turbine 454 is connected downstream of the third steam turbine 353 by means of a third fluid line (not illustrated). Here, the third fluid line is, in a corresponding manner, assigned a second connection device (not illustrated) and a second regulating device (likewise not illustrated) for regulating the flow rate of the working fluid extracted from the third fluid line and/or for regulating the flow rate of the working fluid additionally fed into the third fluid line.

1. A turbine system, comprising:
a first turbine,
a second turbine,
a third turbine,
a central gearbox mechanically coupled at an input side of the central gearbox to the first turbine, the second turbine, and the third turbine, wherein at an output side, the central gear box comprises a mechanical connection for connecting a work machine thereto, wherein said work machine consumes mechanical energy,
a first fluid line for conducting a working fluid from the first turbine to the second turbine,
a second fluid line for conducting the working fluid from the second turbine to the third turbine,
a first connection device assigned to the first fluid line, wherein said first connection device allows a first partial mass flow of the working fluid to be extracted from the first fluid line or supplied to the first fluid line, and
a second connection device assigned to the second fluid line, wherein said second connection device allows a second partial mass flow of the working fluid to be extracted from the second fluid line or supplied to the second fluid line.

2. The turbine system as claimed in claim 1, further comprising:
a first regulating device, assigned to the first connection device for adjusting a magnitude of the first partial mass flow, and/or a second regulating device, assigned to the second connection device for adjusting a magnitude of the second partial mass flow.

3. The turbine system as claimed in claim 1, wherein the first turbine and the second turbine are coupled to the central gearbox by a common shaft.

4. The turbine system as claimed in claim 1, wherein the first turbine and the third turbine are coupled to the central gearbox such that the first turbine can be operated with a first rotational frequency and the third turbine can be operated with a second rotational frequency, wherein the first rotational frequency differs from the second rotational frequency.

5. The turbine system as claimed in claim 1, wherein at least one of the first turbine, the second turbine, and the third turbine comprises a radial turbine.

6. The turbine system as claimed in claim 1, wherein at least one of the first turbine, the second turbine and the third turbine comprises an axial turbine.

7. The turbine system as claimed in claim 6, wherein a rotor of the axial turbine is coupled to an axial shaft, wherein said axial shaft is mounted on the side of the central gearbox and is arranged, without bearings, in a housing of the axial turbine.

8. The turbine system as claimed in claim 7, wherein the rotor of the axial turbine comprises multiple turbine stages, wherein each turbine stage has, arranged around the axial shaft, (a) a row of rotatable rotor blades attached to the rotor, and (b) a row of static guide blades attached to the housing.

9. The turbine system as claimed in claim 8, wherein the rotor blades of a row are attached to a rotor blade carrier, and wherein multiple rotor blade carriers are fixed to the axial shaft by means of a tensile device.

10. The turbine system as claimed in claim 1, further comprising:
a fourth turbine, wherein said fourth turbine is mechanically coupled to the central gearbox,
a third fluid line for conducting the working fluid from the third turbine to the fourth turbine, and
a third connection device assigned to the third fluid line wherein said third connection device allows a third partial mass flow of the working fluid to be extracted from the third fluid line or supplied to the third fluid line.

11. A turbine installation, comprising:
a turbine system as claimed in claim 1, and
a work machine, wherein said work machine is mechanically coupled to the central gearbox.

12. A method for operating a work machine, the method comprising:
providing an energy-containing working fluid, supplying the working fluid to a turbine system as claimed in claim 1, wherein the turbine system extracts at least a part of the energy of the working fluid and converts at least a part of the extracted energy into mechanical work, and
operating the work machine with the converted mechanical work.

13. The turbine system of claim 3, wherein one of the first turbine and the second turbine is arranged on a first side of the central gearbox and the other of the first turbine and the second turbine is arranged on a second side of the central gearbox, wherein the first side is positioned opposite the second side.
